(19) United States
(12) Patent Application Publication
(10) Pub. No.: US 2001/0038268 A1
(43) Pub. Date: Nov. 8, 2001

(54) DEVICE FOR THE ECPOAURE OF PHOTOGRAPHIC RECORDING MATERIAL

(76) Inventors: HERMANN FUCHSBERGER, ISMANING (DE); FRANZ MAIER, MUENCHEN (DE); ROLAND RECKZIEGEL, WOLFRATSHAUSEN (DE)

Correspondence Address: KARL F. MILDE, JR., ESQ., MILDE, HOFFBERG & MACKLIN, L.L.P., 10 BANK STREET, SUITE 460, WHITE PLAINS, NY, 10606

(21) Appl. No.: 09/368,476

(22) Filed: Aug. 4, 1999

(30) Foreign Application Priority Data
Aug. 4, 1998 (DE) 198 35 159.3

(51) Int. Cl. G05F 1/00; H05B 37/02; H05B 39/04; H05B 41/36

(52) U.S. Cl. 315/291

(57) ABSTRACT

A device (1) for the exposure of photographic recording material (6) comprises an exposure system (2) incorporating a multitude of light emitting diodes (12a-12n, . . . , 20a-20n; 40a-40n, . . . , 50a-50n). These light emitting diodes (12a-12n, . . . , 20a-20n; 40a-40n, . . . , 50a-50n) are connected in a combination of at least one series circuit and at least one parallel circuit. This enables a large number of light emitting diodes to be provided in the exposure system (2), permitting a high light intensity and, accordingly, short exposure times. The voltages and currents required to operate the device (1) are therefore modest and do not necessitate a high technical expenditure for their generation.

### BACKGROUND OF THE INVENTION

The present invention relates to a device for the exposure of photographic recording material by means of an exposure system having a plurality of light-emitting diodes.

A device of this type is known from the published European patent application No. EP 0 691 568 A1. This published patent application discloses a photographic printer for exposing individual images of a photographic film on photographic paper. For this purpose, the photographic printer incorporates an exposure station that contains a matrix of light emitting diodes serving as the light source. The light emitting diodes emit light in red green and blue colors. The individual images of the photographic film are exposed using the light source of the exposure station and, thus, the respective picture is projected onto the photographic paper. A mirror is inserted in the beam path of the exposure station, de-coupling a portion of the light and directing it to an image sensor. A photometric measurement of the individual image points of the picture that is to be projected onto the photographic paper is performed using this image sensor. This measurement is carried out separately for the three primary colors red, green and blue. The signals generated by the image sensor are transferred to the various evaluation and control circuits. The amount of exposure required for a correct exposure of the respective image on the photographic paper is determined in this manner. Using a driver circuit, each individual light emitting diode is controlled by its own driver signal. The respective driver signals determine the light intensity and duration for each respective light emitting diode. This permits a very precise exposure of the image on the photographic paper. Based on this individual control of the light emitting diodes, it is said to be particularly possible to compensate for inaccuracies of the light source.

Similar arrangements are known from the published European patent application No. EP 0 424 175 A2 and the German patent No. DE 43 08 884 C2. In these devices, light emitting diodes are used for the exposure of photosensitive materials as well. These light emitting diodes are each controlled by separate exposure signals.

Using light emitting diodes in an exposure system for exposing photographic recording material is advantageous because the light emitting diodes can be switched quickly and controlled directly. A shutter to shut out the exposure beam path can thus be avoided. Such a shutter is subject to very high mechanical requirements. In addition, the light emitting diodes are available in the three primary colors, red, green and blue, such that special color filters are not required for the exposure of the recording material.

To realize an exposure system for exposing photographic recording material, where light emitting diodes are to be used to achieve the advantages described above, it is important to ensure a sufficient brightness of the exposure system in order to achieve short exposure times.

The light emitting diodes available today, with their limited illumination intensity, and the recording materials with their standard light sensitivity necessitate that a large number of light emitting diodes be present in the exposure system, particularly for the red spectral range of the light. Since during operation each of these light emitting diodes a specific amount of current is consumed, typically around 100 mA for many types of light emitting diodes, a high current supply needs to be made available for the known assemblies, according to the state-of-the-art, during exposure of the photographic recording material. The current required during operation can easily reach 50 A and more. In practical applications, such currents are difficult to handle, especially when the light emitting diodes are to be switched on and off for periods of a few μsec.

### SUMMARY OF THE INVENTION

It is, therefore, the principal object of the present invention to realize an exposure system using light emitting diodes in a device for the exposure of photographic recording materials that will provide a sufficiently high intensity for the exposure of recording material.

This object, as well as objects which will become apparent from the discussion that follows, are achieved, in accordance with the present invention, by connecting the light emitting diodes together in a combination of at least one series circuit and at least one parallel circuit, and by providing at least one control system to adjust the light emitted during operation by one or more of the light emitting diodes and, if desired, to change the adjustment of the light during operation of these diodes.

Based on the invention, it is advantageously possible to provide a high number of light emitting diodes in the exposure system through which a high light intensity, and accordingly, short exposure times are made possible. In this manner, a particularly effective and fast device for the exposure of photographic recording material can be made available. In addition, the voltage and current required by the device subject to the invention to operate the light emitting diodes are limited to values that keep the technical expenditure and related costs for handling high voltages and currents low. Due to the device subject to the invention, the control of the light emitting diodes can be simplified and the wiring involved reduced, compared to the known devices according to the state-of-the-art.

Advantageously, the control system is used to adjust the light that is emitted during operation by one or more light emitting diodes is in the device according to the invention. Particularly, the light intensity can be adjusted using this control system. This enables an improvement of the quality of the exposure of the recording material because exposure inaccuracies can be compensated. The cause for such exposure inaccuracies can be, for example, the failure of one or more light emitting diodes. This failure can be compensated by the control system by adjusting the intensity of light emitted by the one or more remaining operational light emitting diodes.

In one embodiment of the present invention, several light emitting diodes are connected in series in series circuit branches, and these series circuit branches, in turn, are connected in parallel. In such an embodiment of the invention, a particularly uniform intensity distribution of the light emitted from the exposure system can advantageously be made possible. This is true especially when the number of light emitting diodes connected in series in the individual series circuit branches is equal.

In an additional advantageous embodiment of the invention, the light emitting diodes of the individual series circuit branches are all integrated on one semiconductor wafer, forming a particularly compact design with a uniform light intensity distribution. In addition, the wiring effort is kept particularly small when using this integrated realization of the exposure system subject to the invention.

According to another embodiment of the device according to the invention, several parallel circuit branches, each featuring light emitting diodes connected in parallel, are connected in series. This design ensures a very high breakdown resistance, because even when one light emitting diode in one of the parallel circuit branches fails, the other light emitting diodes of the parallel circuit branch continue to be operational. Thus, the failure of one light emitting diode does not lead to the breakdown of the entire parallel circuit branch.

In an additional advantageous embodiment of the invention, a separate control system is employed in each of the series circuit or parallel circuit branches. The result of this is that the adjustment of the light emitted by the light emitting diodes is improved even further. The adjustment of the light can be limited, for example, to certain local areas of the exposure system.

For simplicity's sake, an adjustable power source can be used as the control system. It is used to supply a certain current to one light emitting diode or more light emitting diodes where said current is used to determine the intensity of the light emitted by the light emitting diode. For example, a desired light intensity distribution that is used to control the adjustable power source can serve as control parameter.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a representational diagram illustrating an example of an application of the device according to the invention in a digital image generation device.

FIG. 2 is a schematic diagram of a first exemplary embodiment of the exposure system according to the invention.

FIG. 3 is a schematic diagram of a second exemplary embodiment of the exposure system according to the invention.

FIG. 4 is a block diagram of a preferred embodiment of a control system employed in the device according to the invention.

### DESCRIPTION OF THE PREFERRED EMBODIMENTS

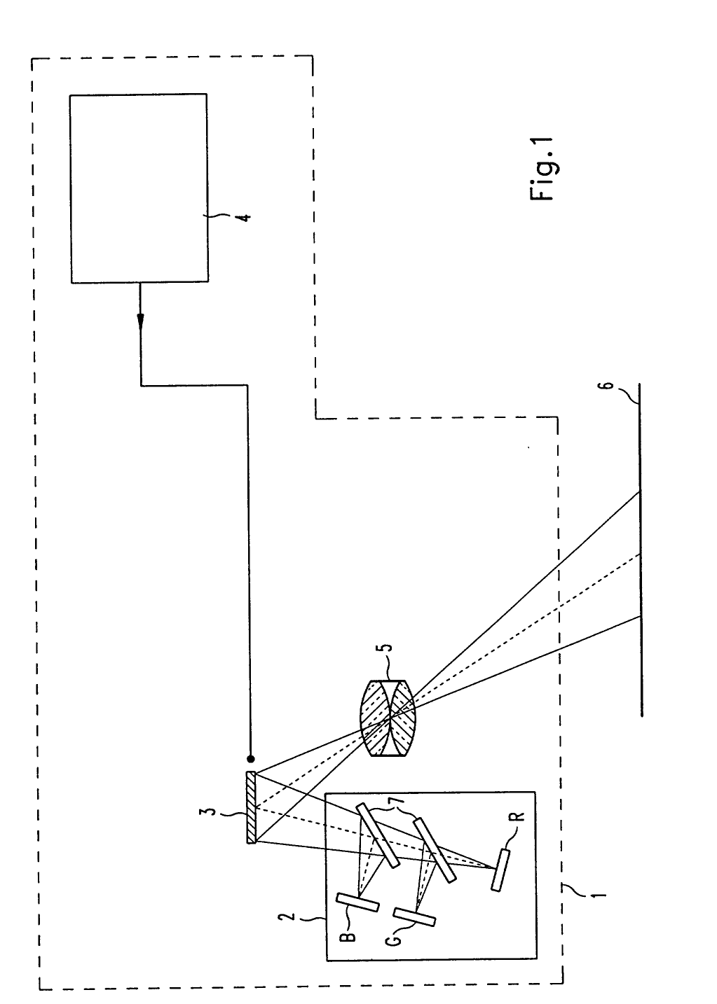

The preferred embodiments of the present invention will now be described with reference to FIGS. 1-4 of the drawings. Identical elements in the various figures are designated with the same reference numerals.

FIG. 1. shows an example of an application for a device subject to the invention for the exposure of photographic recording material in the form of a digital image generation device 1. Using the digital image generation device 1, image information that is available as digital data can be exposed onto a photographic recording material, which in the example shown is conventional photographic paper 6. However, other light-sensitive recording materials, for example, light-sensitive lacquer, can likewise be used. The digital image generation device 1 features a light source 2 that can be used to direct light onto a pixel-controllable light modulator 3. In the example at hand, the light modulator 3 is a digital micro-mirror device or “DMD”. Such a DMD is known, for example, from the published European Patent Application No. EP-OS 0 738 910. DMDs consist of a multitude of individually controllable mirrors that reflect light that is directed towards these mirrors for a certain period. Here, the DMD 3 is aligned such that the reflected light strikes the photographic paper 6 via an objective 5.

For the pixel-control of the DMD 3, the digital image generation device 1 uses a control system 4. The control system 4 contains a memory where the digital data that contain the image information is stored. The digital data can be the image information of an index print, for example. The digital data with the image information is converted into control signals to control the DMD 3 through the control system 4. Each mirror of the DMD 3 is controlled by its own control signal such that it can be moved into a specified position. In this manner, the light directed to the DMD 3 is modulated according to the image information. Due to the light modulation by the DMD 3, varying gray scales are generated on the photographic paper 6. Thus, it is possible to represent an image of the image information on the photographic paper 6. A transmissive light modulator, such as an LCD, for example, can also be used in place of the reflecting light modulator in the form of a DMD 3. However, it must be ensured that the light source 2 is capable of emitting light of sufficient intensity, because the transmissive light modulator will generally absorb a portion of the light.

In the example at hand, the light source 2 contains light emitting diodes (LED) for the generation of light in the three primary colors red, green and blue. These light emitting diodes are assembled in three different LED arrays, with the first LED array R containing all red light emitting diodes, the second LED array G containing all green light emitting diodes, and the third LED array B containing all blue light emitting diodes. The light emitted by the LED arrays R, G and B in the three primary colors is converged via two dichroitic mirrors 7 and directed towards the DMD 3. The green and the blue LED arrays G and B, respectively, contain about 50 to 100 individual light emitting diodes depending on the copy performance of the digital image generation device 1 and the respective performance of the light emitting diodes. About 500 light emitting diodes are provided for the red LED array R because the sensitivity of the photographic paper 6 is particularly low in the red spectral range. The three LED arrays can be controlled individually such that the individual color portions of the image to be shown can either be exposed in succession or mixed together. The light intensity that is to be emitted from each individual LED array in order to achieve a correct exposure of the photographic paper is specified by an exposure control unit not shown here. Methods to determine and adjust the required light intensities are known.

According to the invention, the many light emitting diodes of the respective LED arrays, R, G, and B are connected in a combination of series circuits and parallel circuits. In this manner, both the supply voltage to operate the individual LED arrays and the current necessary during the operation of the LED arrays can be limited. Typical light emitting diodes operate at about 2.2 V and 100 mA. With a relevant high number of light emitting diodes, a parallel circuit of all light emitting diodes would, therefore, lead to a high current. With 500 light emitting diodes, it would be around 50 A. A series circuit of all light emitting diodes would require a supply voltage of about 1000 V. In practical applications, such high voltages and currents are difficult to handle, especially when the light emitting diodes are to be switched on and controlled for periods of a few μsec.

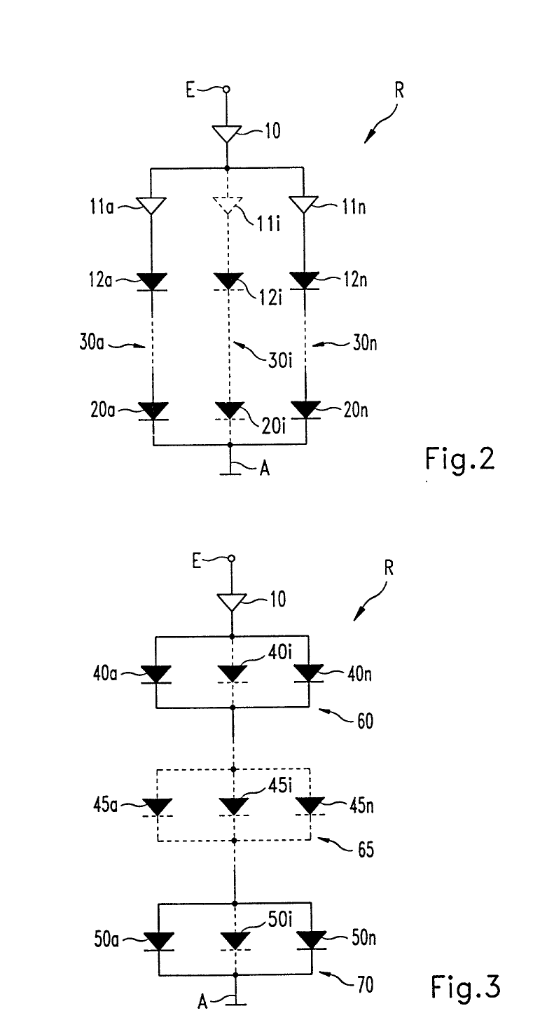

Thus, FIG. 2 shows a first exemplary embodiment of the arrangement subject to the invention of the individual light emitting diodes for the LED array R. Of course, such an arrangement of the light emitting diodes is also possible in the two other LED arrays, G and B. In the first exemplary embodiment according to FIG. 2, several light emitting diodes are connected in series in several series circuit branches. The LED array R contains n series circuit branches 30a, . . . , 30i . . . , 30n each with their light emitting diodes 12a, . . . , 20a, . . . , 12i, . . . , 20i, and 12n, . . . , 20n, respectively connected in series. These n series circuit branches 30a, . . . 30n, in turn, are connected to one another in parallel. One output A of the LED array R, where the individual outputs of the series circuit branches are connected, is connected to ground. The control signal for the LED array is fed to an input E of the LED array R, where the individual inputs of the series circuit branches 30a, . . . , 30n are connected. Advantageously, only one single control signal is required for the operation of all light emitting diodes of the LED array R.

Advantageously, the light emitting diodes 12a, . . . , 20a, . . . , 12i, . . . , 20i, . . . , 12n, . . . , 20n, of the respective series circuit branches 30a, . . . , 30i, . . . , 30n are arranged on one semiconductor wafer to realize the LED array.

This enables a high packing density of the various light emitting diodes of the series circuit branches. Furthermore, no connecting leads are required between the individual light emitting diodes of the series circuit branches, such that parasitic capacities as well as the expenditure for bonding are kept to a minimum.

In this exemplary embodiment, the number of light emitting diodes in the respective series circuit branches is the same. This enables the achievement of a uniform intensity distribution of the light emitted by the LED array R.

In the exemplary embodiment according to FIG. 2 at hand, one adjustable power source 11a, . . . , 11i, . . . , 11n is used in each of the series circuit branches 30a, . . . 30n. Using these power sources 11a, . . . , 11n, a current can be applied to the respective series circuit branches where said power sources are employed. This applied current determines the light intensity of the light emitting diodes that are present in the respective series circuit branch. It is possible to measure the intensity of the light emitted by the light emitting diodes and to compare this intensity with a desired nominal value. An error detected with this method can be used to control the light intensity of the light emitting diodes. Here, this control is achieved with the adjustable power sources 11a, . . . , 11n. This enables the achievement of a particularly uniform light distribution. An additional improvement can be achieved by placing a central, adjustable power source 10 ahead of the parallel connected series circuit branches. Using this power source 10, the entire current fed into the various series circuit branches 30a-30n can be controlled centrally. The intensity of the light to be emitted by the entire LED array R is used as a control parameter.

The arrangement of the light emitting diodes according to the first exemplary embodiment has the additional advantage that when one of the series circuit branches 30a, . . . , 30n fails, the light emitting diodes of the other series circuit branches can continue to emit light. However, this also means that a series circuit branch fails even if only one single light emitting diode of this series circuit branch is defective and constitutes a break in the series circuit branch. In this case, the loss of light might be compensated entirely or in part by an increased light emission of one or more of the other series circuit branches through, for example, a readjustment of the adjustable power source.

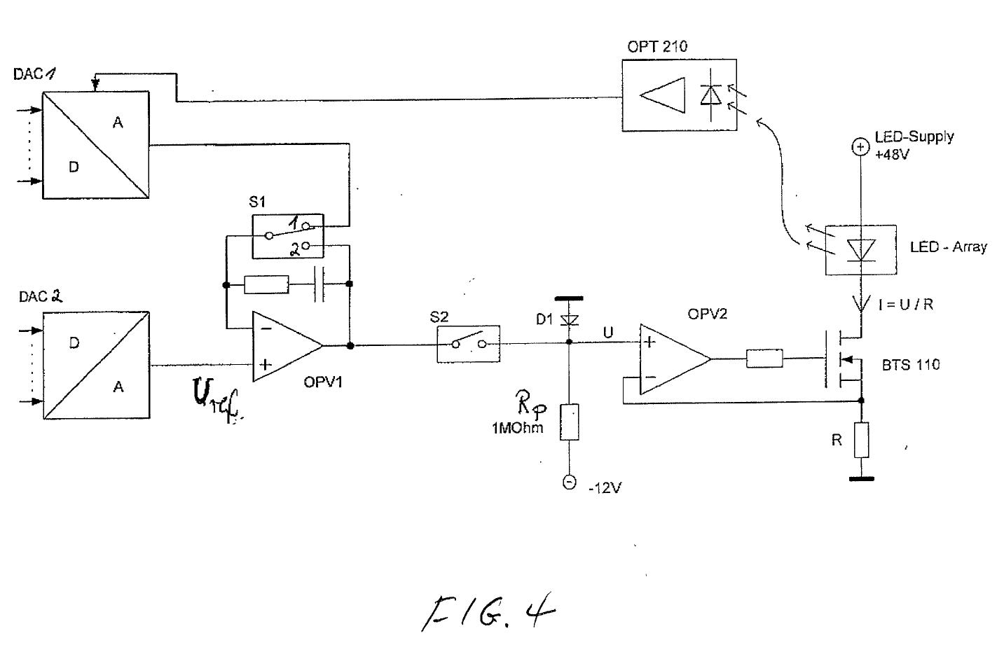

FIG. 3 shows a second exemplary embodiment of the present invention, where several light emitting diodes 40a-40n, . . . , 45a-45n, . . . , 50a-50n are connected in parallel in several parallel circuit branches 60-70, and where these parallel circuit branches 60-70, in turn, are connected in series.

Here, the light emitting diodes of the individual parallel circuit branches are advantageously arranged together on one wafer piece. This results in advantages that have already been described with respect to the first exemplary embodiment according to FIG. 2. In addition, it is advantageous to have the same number of light emitting diodes in each of the respective parallel circuit branches 60-70. This results in a uniform light distribution here as well, as has already been described for the corresponding embodiment of the first exemplary embodiment according to FIG. 2.

An adjustable, central power source 10 is connected ahead of the parallel circuit branches 60-70 that are connected in series, where said central power source is used to define the total current that is to be supplied to the circuit combination of the light emitting diodes 40a-40n, . . . , 50a-50n. The central power source 10 can be used to control the intensity of the entirety of the light emitted by the light emitting diodes of the LED array R. For better localized control of the emitted light, it is also possible to employ such adjustable power supplies in the various parallel circuit branches 60-70.

The number of light emitting diodes in the different branches of the LED arrays R, G or B can be specified at will and is determined by the light intensity of the individual light emitting diodes, by the sensitivity of the photographic paper to be exposed and by the desired performance of the digital image generation device 1. The better the performance of the digital image generation device 1 is to be, the higher the light intensity of the individual LED arrays R, G and B must be. The performance of the digital image generation device 1 determines the number of images that can be exposed onto the photographic paper 6 by the image generation device 1 within a certain time unit, for example one minute.

FIG. 4 illustrates a control system which may be used to control individual LEDs or grouped LEDs within the LED array in accordance with the present invention. The control system provides an adjustable power source, which serves as a current source for the LED array. As shown in FIG. 4, the LED array is connected in series with a MOSFET transistor BTS 110 and a resistor R. The gate of the transistor BTS 110 is connected to the output of an operational amplifier OPV2.

An analog input voltage U is generated at the non-inverting input of amplifier OPV2. Therefore, a current I=U/R is impressed to the LED array. Since the light intensity emitted by the LED array depends on the impressed current I, it is possible to adjust the emitted light by controlling the input voltage U of OPV2.

If a switch S2 is open the LED array is turned off. The input of OPV2 is pulled to a negative potential of approximately −0.6V via the diode D1 and the pull-down resistor Rp. Therefore, it is assured that the MOSFET transistor is turned off.

The triggering of the LED array is done by closing the switch S2. If the switch S2 is closed the output of operational amplifier OPV1 is connected to the input of OPV2. The non-inverting input of OPV1 is connected to a D/A-converter DAC2 which presets a reference voltage U_{ref}. This reference voltage Uref corresponds to the set value of the light intensity emitted by the LED array.

The light intensity emitted by the LED array is detected by an intensity measuring amplifier OPT 210. The signal generated by OPT 210 is weighted by the analog multiplier DAC1. This weighted voltage—representing the actual value of the light intensity emitted by the LED array—is then compared with the set value, the reference voltage U_{ref}, by the OPV1. By way of this adjustment, a nearly constant light intensity can be emitted by the LED array. The switch S1 is in position 1 during adjustment.

For detecting the characteristic response of the LED array the switch S1 is switched into its position 2. The control voltage U is then directly preset as a constant value U_{ref} by the DAC2 and a constant current I is impressed to the LED array.

The arrangement of the light emitting diodes as described in the second exemplary embodiment according to FIG. 3 has the advantage that it has a very high breakdown resistance when one light emitting diode is damaged and, thus, represents a break. In the case of the second exemplary embodiment, this means that in spite of the damage to one light emitting diode in one of the parallel circuit branches 60-70, the other light emitting diodes of the respective parallel circuit branch continue to be able to emit light. However, it should be noted that if an entire parallel circuit branch breaks down, the function of the entire LED array R is interrupted.

There has thus been shown and described a novel device for the exposure of photographic recording material which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In a device (1) for the exposure of photographic recording material (6) by means of an exposure system (2) having a plurality of light emitting diodes (12a-12n, . . . , 20a-20n; 40a-40n, . . . , 50a-50n), the improvement wherein the light emitting diodes (12a-12n, . . . , 20a-20n; 40a-40n, . . . , 50a-50n) are connected in a combination of at least one series circuit and at least one parallel circuit, wherein at least one control system (10, 11a-11n) is coupled to at least one of said circuits to adjust the light to be emitted during operation by one light emitting diode or by a plurality of light emitting diodes (12a-12n, . . . , 20a-20n; 40a-40n, . . . , 50a-50n) and wherein the adjustment of the light to be emitted during operation by said one light emitting diode or said plurality of light emitting diodes (12a-12n, . . . , 20a-20n; 40a-40n, . . . , 50a-50n) can be changed using the control system (10, 11a-11n).

2. The device according to claim 1, wherein several series circuit branches (30a-30n), each with several light emitting diodes (12a-12n, . . . , 20a-20n) connected in series, are connected in parallel.

3. The device according to claim 2, wherein the number of light emitting diodes (12a-12n, . . . , 20a-20n) connected in series is equal in each of the series circuit branches (30a-30n).

4. The device according to claim 2, wherein the light emitting diodes (12a-12n, . . . , 20a-20n) of the respective series circuit branches (30a-30n) are arranged together on one semiconductor wafer.

5. The device according to claim 1, wherein a plurality of parallel circuit branches (60-70), each with a plurality of light emitting diodes (40a-40n, . . . , 50a-50n) connected in parallel, are connected in series.

6. The device according to claim 5, wherein the number of light emitting diodes (40a-40n, . . . , 50a-50n) connected in parallel is equal in each of the parallel circuit branches (60-70).

7. The device according to claim 5, wherein the light emitting diodes (40a-40n, . . . , 50a-50n) of the respective parallel circuit branches (60-70) are arranged together on one semiconductor wafer.

8. The device according to claim 1, wherein one said control system (10, 11a-11n) is present in each of the series circuit branches (30a-30n).

9. The device according to claim 1, wherein one said control system (10, 11a-11n) is present in each of the parallel circuit branches (60-70).

10. The device according to claim 1, wherein the control system (10, 11a-11n) is an adjustable power source.

11. The device according to claim 1, wherein the light to be emitted during operation by the individual light emitting diodes (12a-12n, . . . , 20a-20n; 40a-40n, . . . , 50a-50n) has an intensity maximum in the blue, green or red wave length range of the spectrum.

12. The device according to claim 11, further comprising three exposure systems (R, G, B);
wherein the light emitted during operation by the light emitting diodes of the first exposure system (B) has an intensity maximum in the blue wavelength range of the spectrum;
wherein the light emitted during operation by the light emitting diodes of the second exposure system (G) has an intensity maximum in the green wavelength range of the spectrum; and
wherein the light emitted during operation by the light emitting diodes of the third exposure system (R) has an intensity maximum in the red wavelength range of the spectrum.

13. The device according to claim 1, wherein said device includes a light modulator (3) with a plurality of individually controllable areas, and wherein said light modulator is arranged such that the light emitted during operation by the light emitting diodes (12a-12n, . . . , 20a-20n; 40a-40n, . . . , 50a-50n) is directed towards this light modulator (3).

14. The device according to claim 13, wherein the light modulator (3) is a digital mirror device (DMD).
